(19) United States
(12) Patent Application Publication
(10) Pub. No.: US 2003/0126266 A1
(43) Pub. Date: Jul. 3, 2003

(54) Persistent redirection engine

(76) Inventor: Amir Peles, Tel Aviv (IL)

Correspondence Address: KATTEN MUCHIN ZAVIS ROSENMAN, 575 MADISON AVENUE, NEW YORK, NY, 10022-2585, US

(21) Appl. No.: 10/335,715

(22) Filed: Jan. 2, 2003

Related U.S. Application Data
(60) Provisional application No. 60/345,086, filed on Jan. 3, 2002.

(51) Int. Cl. G06F 15/16; G06F 15/173

(52) U.S. Cl. 709/228; 709/203; 709/225

(57) ABSTRACT

During a web transaction initiation, a switch selects a specific server with which to connect; however, it will not pass the request to the server but, rather, will instruct the client to connect to another IP address corresponding to the specific server. This IP address is an additional address on the switch that will always send the requests to the same server. As long as the server is active and capable of serving users, the user will perform remaining transactions towards this IP address and will remain connected to the same server. Once the server is down, the switch recognizes the situation and all subsequent requests received are responded to with a new address for use. The new address is an address of another server that is active and to which the user may connect.

This application claims the benefit under 35 U.S.C. §119(e) from provisional application serial No. 60/345,086 filed on Jan. 3, 2002.

### BACKGROUND OF THE INVENTION

1. Field of Invention

The present invention relates to the area of Internet communications. Particularly, the present invention relates to maintaining high quality server connections during consumer-related transactions.

2. Discussion of Prior Art

Many web transactions today are comprised of multiple phases. First, a user connects to a service and receives authentication by the server. Next, the user requests catalogue information regarding the content of the site and the user chooses some items for purchase. Lastly, the user requests to buy the items and negotiates encryption parameters with the servers. The encrypted transaction uses these encryption parameters to securely pass the user's credit card number and pays for the items.

When multiple users connect to a site, there may be a requirement for use of more than one server machine. By forming a group of servers with identical content, user requests may be distributed between the various server machines. The construction of a group of server machines generates an unlimited scalable architecture as the number of users grows. Once a user is connected to a certain server, should subsequent traffic generated by such a user reach a different server, the session will not proceed, as the different server is not familiar with the user. Consequently, the same server should handle subsequent traffic generated by a single user. This server would authenticate the user, store the list of items the user chooses to purchase, and complete the financial transaction. If at any phase the user would reach another server, the transaction would be terminated since the user was not authenticated by the server and has no secure connection with it. There are several partial solutions that offer a way to ensure that traffic from any single user will remain persistent on the same server.

One prior art solution suggests that a switch be placed in front of the servers, wherein the switch has a single IP address that all users shall connect to. The switch selects the server that handles the whole phase of the user's transaction. In accordance with existing solutions, the switch would pass the request to the server and would store in its memory the fact that the user was connected to that specific server. A user is identified by an associated IP address. In the following user requests, the switch recognizes the user's IP address. Thereafter, the switch will forward the user's request to the same server that was previously chosen. This solution is limited due to the fact that the switch has limited memory and is not able to store information for all users for a long period of time. Furthermore, the user may use different IP addresses in different sessions, in which case the switch will not be able to identify the following session of such user.

In an alternative solution, the server or the switch can issue a “cookie,” which the user will store. In all subsequent connections of that user, the cookie shall be sent with the user's request. The switch searches for the cookie in the request, identifies the relevant server for this cookie value, and may send the request to the specific server that issued the cookie. This mechanism is limited due to the fact that when the session is encrypted (for the actual transaction), the switch is not able to identify any of the content of the transaction. Moreover, it demands additional functionality and memory of the user to store the cookies' data.

In any event, the precise merits, features, and advantages of the above-mentioned prior art, do not achieve or fulfill the purposes of the present invention.

### SUMMARY OF THE INVENTION

The present invention provides a mechanism to maintain the persistence of a connection between a user and one of the servers in a server farm. Furthermore, this mechanism verifies the status of the servers and may maintain the full availability of the service to the users even in the event that a server fails. The present invention improves upon the prior art limitations of memory, encrypted sessions, or client address changes.

The switch in the present invention receives an initial connection request from a client and determines through a selection criteria the most appropriate server to handle the client request. After the switch selects the server for the user's initial request, it will not pass the request to the server but, rather, will instruct the client to connect to another IP address. This IP address is an additional address on the switch that the switch relates to a server. In subsequent requests from the client, which include this IP address, the switch will recognize this IP address and will send the subsequent requests to the same server. This occurs as long as the server is active and capable of serving users. The user will then perform the remaining part of the transaction towards this IP address and remain connected to the same server.

Once a server is down, the switch will recognize the situation, and all subsequent requests received are responded to using a new IP address. The new IP address is an address of an additional server that is active which the user may connect to. This phase may disturb the current transaction since the user is required to renegotiate his/her details with a new server; however, it will not cause the connection to fail and the user continues to be served.

### BRIEF DESCRIPTION OF THE DRAWINGS

FIG. 1 illustrates a generalized operational view of the present invention's switch.

FIG. 2 illustrates how the present invention's switch handles a new communication request from a client.

FIG. 3 illustrates a connected session using the present invention.

FIG. 4 illustrates a second connected session using the present invention.

FIG. 5 illustrates a future transaction using the present invention.

FIG. 6 illustrates how the present invention's switch handles a future transaction in a failure on a server scenario.

FIG. 7 illustrates how the present invention's switch handles a new client request in the presence of faulty servers.

### DESCRIPTION OF THE PREFERRED EMBODIMENTS

This invention is illustrated and described in a preferred embodiment, however the invention may be produced in many different configurations. Depicted in the drawings and described herein in detail is a preferred embodiment of the invention, based on the understanding that the present disclosure is an exemplification of the principles of the invention and the associated functional specifications for its construction, which is not intended to limit the invention to the embodiment illustrated. Those skilled in the art may envision other possible variations within the scope of the present invention.

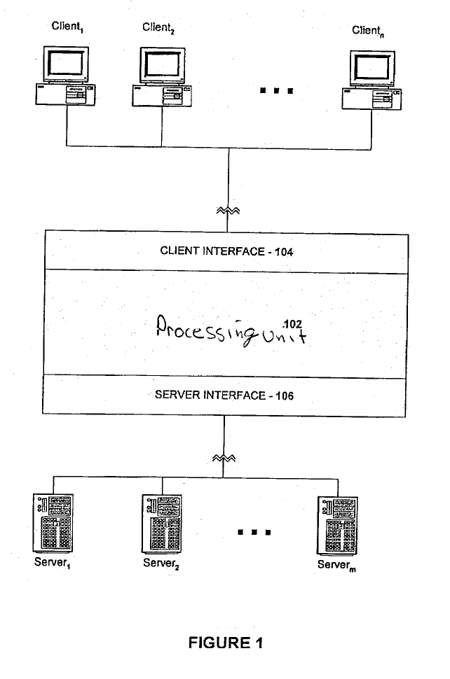

FIG. 1 illustrates a generalized operational view of the present invention's switch. The switch has a processing unit 102, a client interface 104 and a server interface 106. The client interface 104 facilitates communication with a plurality of clients (Client₁ through Clientₙ). Similarly, the server interface 106 facilitates communication with a plurality of servers (Server₁ through Serverₘ). The processing unit 102 interrogates client request, facilitates communication between clients and the plurality of servers including forwarding and redirecting requests, a decision engine for determining an appropriate server, and determines actions on server failure. These elements may be implemented as a combination of hardware and software.

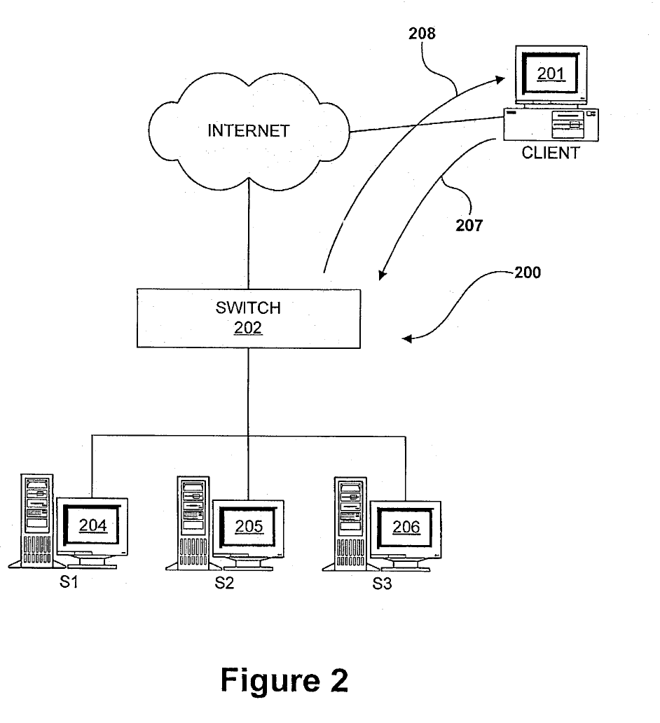

FIGS. 2-7 collectively illustrate the functionality of the present invention's switch. FIG. 2 illustrates how the present invention's switch handles a new client request. The present invention's switch 202 interceded between the client 201 and one or more servers 204, 205, 206 (S₁, S₂, S₃) required for a connected session 200. However, after the switch selects a specific server, it will not pass the request to the server but, rather, will instruct the client to connect to another IP address.

The operation of the switch is such that it maintains multiple virtual IP addresses. One IP address is a global IP address for the entire service. This is the address to which all DNS requests, or all the requests from new clients, arrive. When the switch receives requests (e.g., a DNS-based request, HTTP-based request, real time streaming protocol (RTSP) based request, session initiation protocol (SIP) based request, or a request based on a protocol that supports a redirection command) to this address 207, it may use a resolution or redirection command (or any other command available in that protocol) to instruct the client to contact another address 208.

The other virtual addresses are defined per server. Each server has a virtual address (VIP₁, VIP₂, VIP₃) that it represents, and there are other servers for backup (e.g., VIP₁ has S₂, S₃ for backup). The switch receives an initial request 207 from a client and selects the most available server for the current transaction, and the address that shall represent the server is replied to the client 208. This is the address that the client is instructed to contact for the remainder of the communication.

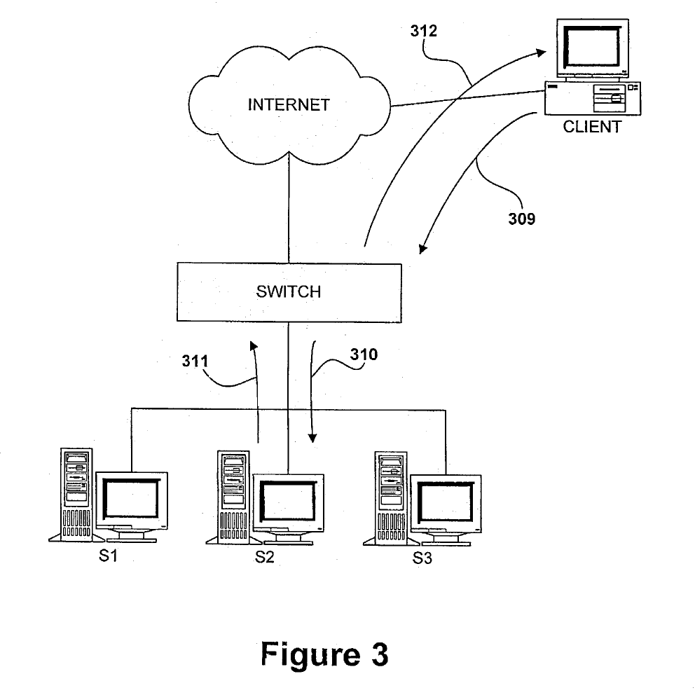

FIG. 3 illustrates a connected session based upon the present invention. When the client subsequently connects, the client will always connect to the address provided previously. The switch will forward the request to the selected server. There is no requirement for memory on the switch in order to recognize the client, and there is no information other than the IP address that the client must be familiar with. The sequence is, for example: request to VIP₂ 309 which includes the virtual IP address of the server S₂. The switch receives this request, recognizes the VIP₂ and passes the request to S₂ 310. The server S₂ may make a response back to the switch for client 311, and the switch passes the response to client 312.

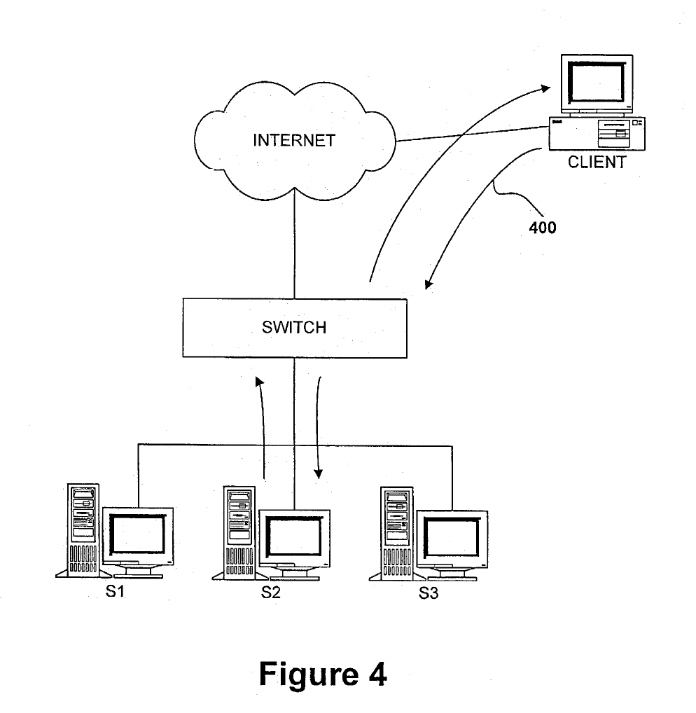

FIG. 4 illustrates a second connected session using the present invention. When the reply is passed back, it will be forwarded to the client. When the client attempts to establish another session, it continues to use the same address VIP₂ 400 in the next request. Even when the information is encrypted, the address is still visible, and the switch will direct the client's request to the same server S₂ that served all previous sessions. It should be noted that this mechanism works even when the client changes its own IP address during a session.

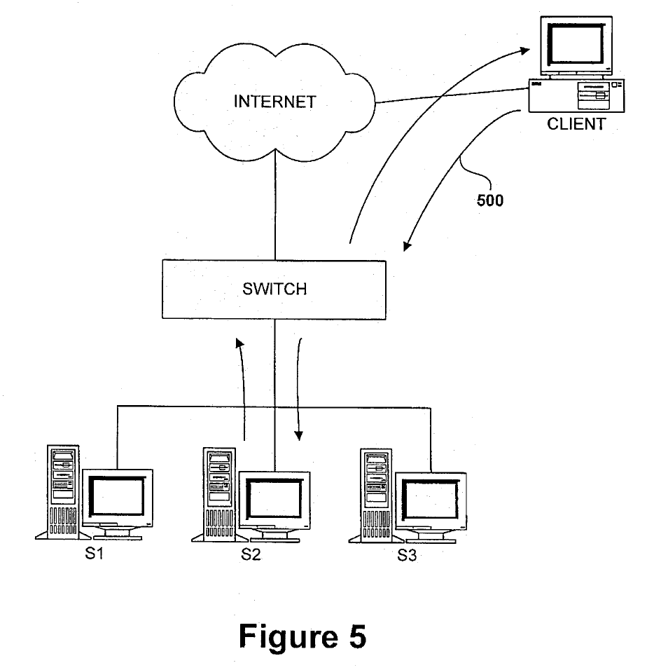

The client may require the service again sometime in the future (as in FIG. 5). At such time, the client may continue to use the same address VIP₂ 500 for persistence. Despite the time that has passed, the requests will continue to be handled by the same server S₂ that served the previous requests.

Hence, it should be noted that unlike the “cookie” scenario of the prior art, clients communicating with the present invention's switch do not have to store cookies locally (for future communication sessions). The client may continue to use the same address VIP. Additionally, the server doesn't have to keep any information regarding a session that ends.

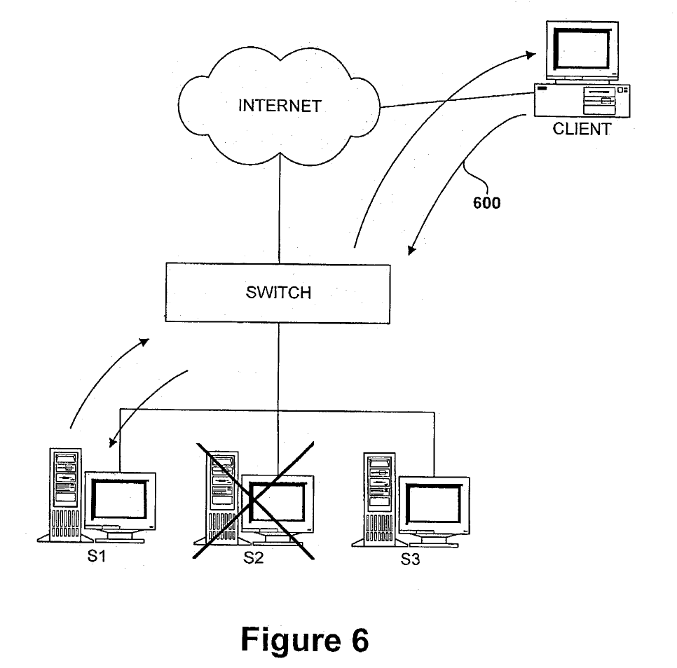

FIG. 6 illustrates how the present invention's switch handles a future transaction in a failure on a server scenario. Failures in the system may unfortunately still occur with regard to the servers. In the event that the server (S₂) fails and the client attempts 600 to connect to the address (VIP₂) that it is familiar with 600, the switch will receive the request and use one of the backup servers (e.g., S₁) to serve the client. Since the backup server is not familiar with the client, the client will then be required to renegotiate its identity and status; however, it will not suffer any downtime.

In the server failure scenario of FIG. 6, when the switch selects one of the backup servers, the switch may respond back to the client with the VIP of the selected backup server. This is similar to the initial request illustrated in FIG. 2. In an alternative embodiment if the identified virtual network address from the communication request corresponds to a faulty server, the switch would select one of the backup servers and pass, transparent to the requesting entity, the communication request to the selected backup server. The switch could also use a combination of these two embodiments.

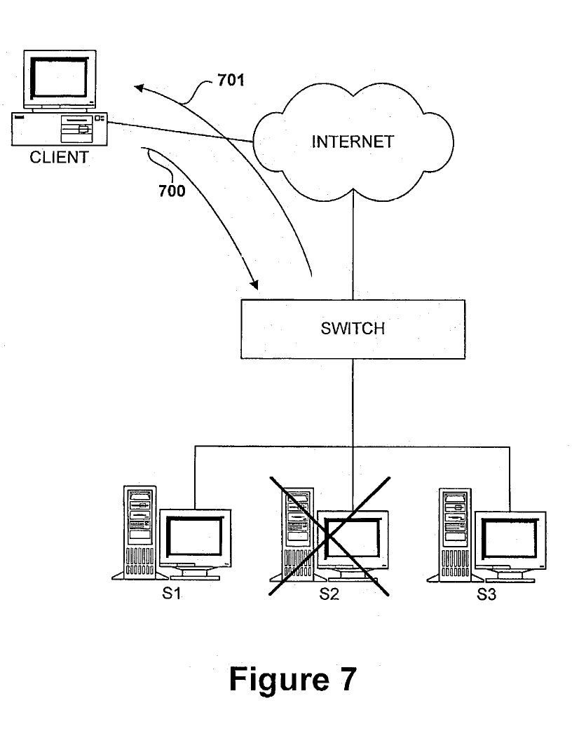

FIG. 7 illustrates how the present invention's switch handles a new client request in the presence of faulty servers. When new clients subsequently reach the site address via the primary global IP, the decision mechanism will select between the available servers and will ensure that clients do not access the failed servers (as shown in FIG. 7). Thus, in the presence of a faulty server (server S₂), an incoming request from a new client is received by the switch of the present invention as in 700 and the switch provides a redirection reply 701 that provides the new client with the virtual IP address of either server S₁ (VIP₁) or S₃ (VIP₃) for future communication.

### CONCLUSION

A system and method has been shown in the above embodiments for the effective implementation of a persistent redirection engine. While various preferred embodiments have been presented and described herein, the invention is not intended to be limited by such disclosure, but rather, the invention is intended to cover all modifications and alternate constructions which are within the spirit and scope of the invention, as defined in the appended claims. For example, the present invention should not be limited by software/program, computing environment, specific computing hardware, and specific numbers of users, servers, switches, or web sites. The above enhancements are implemented in various computing environments. The programming of the present invention may be implemented by one of skill in the art of Internet/Web or network/server programming.

1. A method for performing transactions over a network, said method implemented in a switch comprising the steps of:
a. establishing a communication session with a requesting client;
b. receiving cached information from a client, said cached information having at least a virtual network address;
c. associating said virtual network address with a server; and
d. checking if said associated server is faulty, and if so,
i. identifying a non-faulty server and transmitting, to said client, a network address associated with said non-faulty server, whereby said client renegotiates transaction parameters with identified non-faulty server without terminating said communication session; else
ii. redirecting communications from said client to a non-faulty server corresponding to said virtual network address in said cached information.

2. A method as per claim 1, wherein said network comprises any of: local area network (LAN), wide area network (WAN), or the Internet.

3. A method as per claim 1, wherein each of said network addresses is an IP address.

4. A method for persistently redirecting communication requests, said method implemented in a switch, said switch having a unique global network address and a plurality of virtual network addresses corresponding to a plurality of servers, said method comprising the steps of:
a. receiving a communication request from a requesting entity; and
b. if said communication request is addressed to said unique global network address, then:
i. identifying a virtual network address associated with a server for said requesting entity to establish a communication; and
ii. transmitting said virtual network address to said requesting entity, whereby said requesting entity addresses communications to said identified virtual network address;
c. else:
i. identifying a virtual network address from said communication request;
ii. identifying a server corresponding to said identified virtual network address; and
iii. redirecting subsequent communications from said requesting entity to said identified server.

5. A method as per claim 4, wherein said method further comprises the steps of:
a. identifying one or more faulty servers in said plurality of servers and identifying corresponding virtual network address associated with said one or more faulty servers; and
b. if said identified virtual network address from said communication request corresponds to a faulty server, including one of the sub-steps of:
i. transmitting to said requesting entity a new virtual address corresponding to a non-faulty server for further communications, and
ii. selecting one of said non-faulty servers and passing, transparent to said requesting entity, said communication request to said selected non-faulty server.

6. A method as per claim 4, wherein said steps of the method are implemented across networks.

7. A method as per claim 6, wherein said across networks element comprises any of:
local area networks (LAN), wide area networks (WAN), or the Internet.

8. A method as per claim 4, wherein each of said network addresses is an IP address.

9. A method as per claim 4, wherein said communication request is any of the following:
a domain name service (DNS) request, a hypertext transfer protocol (HTTP) based request, a real time streaming protocol (RSTP) based request, a session initiation protocol (SIP) based request, or a request of a protocol that supports a resolution or redirection command.

10. A switch interfacing a plurality of servers with one or more clients, said switch comprising:
a. a client interface receiving communications from said one or more clients, said communications addressed either to a global network address associated with said switch or a virtual network address associated with a server in said plurality of servers; and
b. a server interface in communication with said client interface, said server interface facilitating communication with said plurality of servers and identifying faulty and non-faulty servers in said plurality of servers, and
i. if a communication from a client is addressed to a global network address, then instructing said client interface to transmit a virtual network address associated with a non-faulty server to said client; else
ii. if said communication from said client is addressed to a virtual network address associated with a non-faulty server, then
redirecting communications from said client to said non-faulty sever corresponding to said virtual network address, else at least one of
instructing said client interface to transmit a new virtual network address associated with a non-faulty server to said client, and selecting a non-faulty server and passing, transparent to said client interface, said communication to said selected non-faulty server.

11. A switch interfacing a plurality of servers with one or more clients, as per claim 10, wherein said client interface communicates with said clients over a network.

12. A switch interfacing a plurality of servers with one or more clients, as per claim 11, wherein said network is any of the following: local area network (LAN), wide area network (WAN), or the Internet.

13. A switch interfacing a plurality of servers with one or more clients, as per claim 10, wherein said network addresses are IP addresses.

14. A switch interfacing a plurality of servers with one or more clients, as per claim 10, wherein said communications are any of the following: HTTP-based communication, DNS-based communication, RTSP-based communication, SIP-based communication, or a communication based on a protocol that supports a resolution or redirection command.

15. A method for persistently redirecting communication requests, said method implemented in a switch, said switch having a unique global network address and a plurality of virtual network addresses corresponding to a plurality of servers, said method comprising the steps of:
a. receiving a communication request from a requesting entity; and
b. identifying faulty servers and non-faulty servers among said plurality of servers;
c. if said communication request is addressed to said unique global network address, then:
i. identifying a virtual network address associated with a non-faulty server for said requesting entity to establish said communication request; and
ii. transmitting said virtual network address to said requesting entity, whereby said requesting entity addresses further communications to said virtual network address;
d. else:
i. identifying a virtual network address from said communication request;
ii. if said identified virtual address from said communication request corresponds to a non-faulty server, then:
redirecting subsequent communications from said requesting entity to said identified server, else at least one of
identifying and transmitting a new virtual network address associated with a non-faulty server and instructing said requesting entity to renegotiate a communication session using said new virtual network address, and selecting a non-faulty server and passing, transparent to said requesting entity, said subsequent communications to said selected non-faulty server.

16. A method as per claim 15, wherein said steps of the method are implemented across networks, said networks including any combination of local area networks (LAN), wide area networks (WAN), or the Internet.

17. A method as per claim 15, wherein said network address is an IP address.

18. A method as per claim 15, wherein said communications are any of the following:
HTTP-based communication, DNS-based communication, RTSP-based RADW 19.128 communication, SIP-based communication, or a communication based on a protocol that supports a resolution or redirection command.

19. A system for persistently redirecting communication requests from clients without utilizing client stored cookies, said system having a unique global network address and a plurality of virtual network addresses corresponding to a plurality of servers, said system comprising:
a client interface unit that connects to at least one client and sending and receiving communications with a client;
a server interface unit for connecting to said plurality of servers and for sending and receiving communications with said plurality of servers;
a processing unit that identifies an address in a received communication request from a client, if said communication request is addressed to said unique global network address, then identifying a virtual network address associated with a server for said requesting client to establish communication with and providing said virtual network address to said client interface unit for transmitting to said requesting client,
wherein said requesting client addresses subsequent communications to said virtual network address and said processing unit receiving subsequent communications redirecting the subsequent communications from said requesting client to a server identified by the virtual network address included in the subsequent communications.

20. The system of claim 19, wherein said processing unit further identifies faulty servers and servers among said plurality of servers and when said communication request corresponds to a faulty server at least one of
identifying and transmitting a new virtual network address associated with a non-faulty server to said client, and
selecting a non-faulty server and passing, transparent to said requesting client, said subsequent communications to said selected non-faulty server.
